(19) United States
(12) Patent Application Publication
(10) Pub. No.: US 2025/0388327 A1
(43) Pub. Date: Dec. 25, 2025

(54) AIR CONDITIONING AND VAPOR CYCLE SYSTEM

(71) Applicant: Hamilton Sundstrand Corporation, Charlotte, NC (US)

(72) Inventor: Louis J. Bruno, Ellington, CT (US)

(21) Appl. No.: 19/202,602

(22) Filed: May 8, 2025

Related U.S. Application Data
(60) Provisional application No. 63/663,898, filed on Jun. 25, 2024.

(51) Int. Cl. B64D 13/06; B60H 1/00

(52) U.S. Cl. CPC B64D 13/06; B60H 1/00021; B60H 1/00807; B64D 2013/0674

(57) ABSTRACT

An air conditioning system of a vehicle includes an air cycle system configured to receive a medium and provide a conditioned form of the medium to one or more loads. A vapor compression cycle has a closed loop configuration and a liquid loop through which a first liquid circulates is thermally and fluidly connected to the vapor compression cycle. The liquid loop is also thermally and fluidly connected to the air cycle system at an air cycle system heat exchanger. The liquid loop includes a heat exchanger arranged upstream from the air cycle system heat exchanger relative to a flow of the first liquid. The first liquid is arranged in a heat transfer relationship with a second liquid at the heat exchanger. The first liquid is cooled by the second liquid and/or the medium to achieve a desired temperature at a location downstream from the air cycle system heat exchanger.

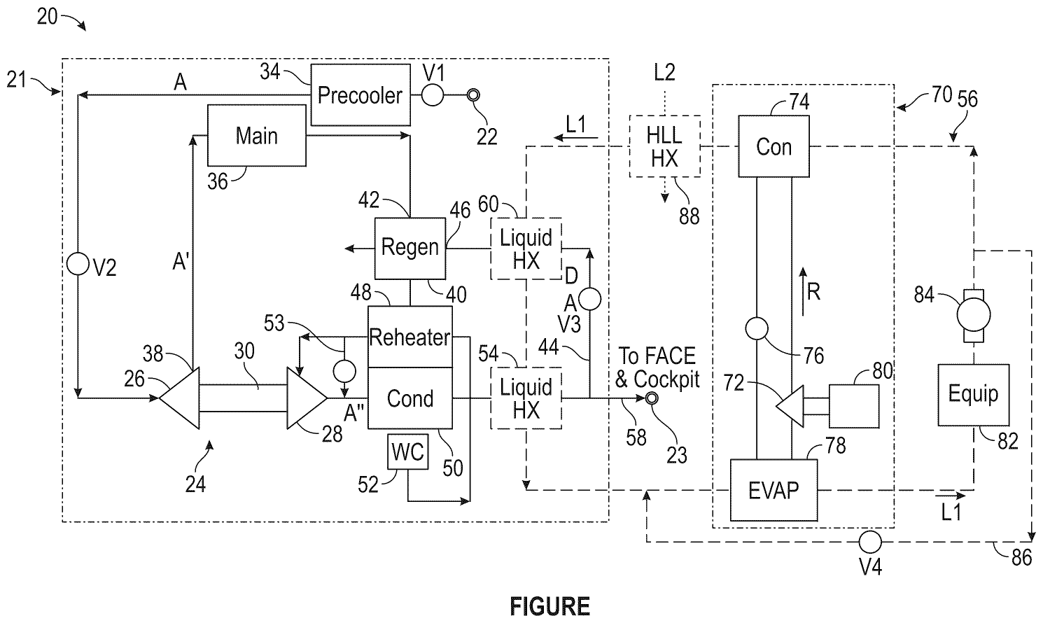

### CROSS-REFERENCE TO RELATED APPLICATIONS

This application claims the benefit of U.S. Provisional Application No. 63/663,898 filed Jun. 25, 2024, the disclosure of which is incorporated herein by reference in its entirety.

### BACKGROUND

Exemplary embodiments pertain to an environmental control system of an aircraft, and more particularly, to an air conditioning system having a vapor compression system thermally coupled to an air cycle system via a cold liquid loop.

An aircraft includes at least several nonintegrated cooling systems configured to provide temperature control to various regions of the aircraft. For example, an aircraft air conditioning system primarily provides heating and cooling to the aircraft cabin area. Since each system has a significant weight and power requirement, the overall efficiency of the aircraft is affected by these nonintegrated systems.

### SUMMARY

According to an embodiment, an air conditioning system of a vehicle includes an air cycle system configured to receive a medium and provide a conditioned form of the medium to one or more loads. The air cycle system includes at least one air cycle system heat exchanger. A vapor compression cycle has a closed loop configuration and a liquid loop through which a first liquid circulates is thermally and fluidly connected to the vapor compression cycle. The liquid loop is also thermally and fluidly connected to the air cycle system at the at least one an air cycle system heat exchanger. The liquid loop includes a heat exchanger arranged upstream from the at least one an air cycle system heat exchanger relative to a flow of the first liquid. The first liquid is arranged in a heat transfer relationship with a second liquid at the heat exchanger. The first liquid is cooled by the second liquid and/or the medium such that the first liquid has a desired temperature at a location downstream from the at least one an air cycle system heat exchanger.

In addition to one or more of the features described above, or as an alternative, in further embodiments cooling of the first liquid at the at least one air cycle system heat exchanger is controlled at least partially in response to a cooling capacity of the second liquid.

In addition to one or more of the features described above, or as an alternative, in further embodiments cooling of the first liquid at the at least one air cycle system heat exchanger is controlled at least partially in response to an ambient air temperature.

In addition to one or more of the features described above, or as an alternative, in further embodiments an amount of medium provided to the air cycle system is controlled in response to at least one of a cooling capacity of the second liquid and an ambient air temperature.

In addition to one or more of the features described above, or as an alternative, in further embodiments the at least one air cycle system heat exchanger includes a first air cycle system heat exchanger and a second air cycle system heat exchanger. The first air cycle system heat exchanger and the second air cycle system heat exchanger are arranged in series relative to a flow of first liquid within the liquid loop.

In addition to one or more of the features described above, or as an alternative, in further embodiments the second air cycle system heat exchanger is arranged downstream from and in series with the first air cycle system heat exchanger relative to a flow of medium within the air cycle system.

In addition to one or more of the features described above, or as an alternative, in further embodiments the medium at an outlet of the first air cycle system heat exchanger is the conditioned form of the medium. The conditioned form of the medium is separated into a first portion deliverable to the one or more loads and a second portion deliverable to the second air cycle system heat exchanger.

In addition to one or more of the features described above, or as an alternative, in further embodiments the at least one air cycle system heat exchanger is an air-liquid heat exchanger.

In addition to one or more of the features described above, or as an alternative, in further embodiments the vapor compression cycle includes a condenser and an evaporator. The liquid loop is thermally and fluidly connected to the vapor compression cycle at at least one of the condenser and the evaporator.

In addition to one or more of the features described above, or as an alternative, in further embodiments the heat exchanger in which the first liquid is arranged in the heat transfer relationship with the second liquid is located directly downstream from the condenser relative to the flow of the first liquid.

In addition to one or more of the features described above, or as an alternative, in further embodiments the first liquid is less than or equal to a specific condenser temperature at an inlet of the condenser.

In addition to one or more of the features described above, or as an alternative, in further embodiments the specific condenser temperature is 130° F.

In addition to one or more of the features described above, or as an alternative, in further embodiments the first liquid is fuel.

According to an embodiment, a method of operating an air conditioning system includes conditioning a medium within an air cycle system including at least one air cycle system heat exchanger, circulating a working fluid through a vapor compression system having a condenser, and circulating a first liquid through a liquid loop. The liquid loop is thermally and fluidly coupled to both the air cycle system at the at least one air cycle system heat exchanger and is thermally and fluidly coupled to the vapor compression system at the condenser. The method includes controlling a flow of medium at the at least one air cycle system heat exchanger such that a temperature of the first liquid at an inlet of the condenser is less than or equal to a specific condenser temperature.

In addition to one or more of the features described above, or as an alternative, in further embodiments the specific condenser temperature is 130° F.

In addition to one or more of the features described above, or as an alternative, in further embodiments cooling the first liquid at the at least one air cycle system heat exchanger via the flow of medium.

In addition to one or more of the features described above, or as an alternative, in further embodiments the liquid loop includes a heat exchanger, the first liquid being arranged in a heat transfer relationship with a second liquid at the heat exchanger. Controlling the flow of medium at the at least one air cycle system heat exchanger such that the temperature of the first liquid at the inlet of the condenser is less than or equal to the specific condenser temperature includes the controlling the flow of medium provided to the air cycle system in response to the temperature of the first liquid at an outlet of the heat exchanger.

In addition to one or more of the features described above, or as an alternative, in further embodiments the temperature of the first liquid at the outlet of the heat exchanger is dependent on a cooling capacity of the second liquid at the heat exchanger.

In addition to one or more of the features described above, or as an alternative, in further embodiments the temperature of the first liquid at the outlet of the heat exchanger is dependent on an ambient air temperature.

In addition to one or more of the features described above, or as an alternative, in further embodiments adjusting the flow of medium provided to the air cycle system based on a difference between the temperature of the first liquid at the outlet of the heat exchanger and the specific condenser temperature.

### BRIEF DESCRIPTION OF THE DRAWINGS

The following descriptions should not be considered limiting in any way. With reference to the accompanying drawings, like elements are numbered alike:

The FIGURE is a schematic diagram of an environmental control system according to an embodiment.

### DETAILED DESCRIPTION

A detailed description of one or more embodiments of the disclosed apparatus and method are presented herein by way of exemplification and not limitation with reference to the FIGURE.

With reference now to the FIGURE, a schematic diagram of a portion 20 of an environmental control system (ECS), such as an air conditioning system for example, is depicted according to non-limiting embodiments as illustrated. Although the air conditioning system 20 is described with reference to an aircraft, alternative applications, such as another vehicle for example, are also within the scope of the disclosure. As shown in the FIGURE, the air conditioning system 20 can include an air cycle system 21 operable to receive a medium A at an inlet 22 and provide a conditioned form of the medium A, also referred to herein as a conditioned medium, to one or more loads via an outlet 23. In an embodiment where the air conditioning system 20 is used in an aircraft application, the medium A provided to the inlet 22 may be bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

In another embodiment, the medium A provided to the inlet 22 is fresh air, such as outside air for example. The outside air can be procured via one or more scooping mechanisms, such as an impact scoop or a flush scoop for example. In an embodiment, the medium A is ram air drawn from a portion of a ram air circuit. Generally, the fresh or outside air as described herein is at an ambient pressure equal to an air pressure outside of the aircraft when the aircraft is on the ground and is between an ambient pressure and a cabin pressure when the aircraft is in flight. In such embodiments, the fresh air may be pressurized by an electrically powered compressor upstream from the inlet 22.

The air cycle system (ACS) 21 additionally includes at least one thermodynamic device 24. A thermodynamic device 24 is a mechanical device that includes components for performing thermodynamic work on a medium (e.g., extracts work from or applies work to the medium A by raising and/or lowering pressure and by raising and/or lowering temperature). Examples of a thermodynamic device 24 include an air cycle machine, such as a two-wheel air cycle machine, a three-wheel air cycle machine, a four-wheel air cycle machine, etc. As shown, the thermodynamic device 24, also referred to herein as an air cycle machine, may include a compressor 26 and at least one turbine 28 operably coupled by a shaft 30. In an embodiment, the thermodynamic device 24 a single turbine 28. However, embodiments including multiple turbines, for example arranged in series or parallel relative to a flow of the medium A are also contemplated herein.

A compressor 26 is a mechanical device configured to raise a pressure of a medium and can be driven by another mechanical device (e.g., a motor or a medium via a turbine). Examples of compressor types include but are not limited to centrifugal, diagonal or mixed-flow, axial-flow, reciprocating, ionic liquid piston, rotary screw, rotary vane, scroll, diaphragm, air bubble, etc. A turbine, such as turbine 28 for example, is a mechanical device that expands a medium and extracts work therefrom (also referred to as extracting energy) to drive the compressor 26 via the shaft 30.

The ACS 21 may include at least one heat exchanger operable to condition the medium A. As shown, the medium A provided at the inlet 22 may be conditioned, for example cooled, within a heat exchanger 34 before being delivered to the thermodynamic device 24. Another medium provided as a heat sink within the heat exchanger 34 to cool the medium A may be ram air, engine fan air, or fuel. In the illustrated, non-limiting embodiment, the outlet of the heat exchanger 34 is fluidly connected to an inlet of the thermodynamic device 24, such as an inlet of the compressor 26. Accordingly, the cooled medium A output from the heat exchanger 34 may be provided directly to the compressor 26. The act of compressing the medium A (within the compressor 26) heats and increases the pressure of the medium A.

An inlet of a main heat exchanger 36 is fluidly connected to the outlet of the compressor 26. The compressed medium A′ output from the compressor outlet 38 may be conditioned, for example further cooled, within the main heat exchanger 36. Any suitable secondary fluid or medium may be used to cool the compressed medium A′ within the main heat exchanger 36.

A first inlet 42 of a regeneration heat exchanger 40 may be located directly downstream from and in fluid communication with the main heat exchanger 36 relative to the flow of the compressed medium A′. In an embodiment, the regeneration heat exchanger 40 is an air-air heat exchanger configured to utilize excess cooling capacity of the ACS 21 to further cool the compressed medium A′. For example, as will be described in more detail below, part of a conditioned form of the medium ready to be delivered to one or more loads of the vehicle, such as the cockpit for example, may be diverted along a regeneration pathway 44 to a second inlet 46 of the regeneration heat exchanger 40. At the regeneration heat exchanger 40, the compressed medium A′ may be cooled via a thermal exchange with this diverted medium DA. The heated diverted medium DA may then be exhausted overboard or provided to another component of subsystem of the aircraft.

An outlet of the regeneration heat exchanger 40 may be fluidly connected to a dehumidification system. In the illustrated, non-limiting embodiment, the dehumidification system includes a reheater 48, a condenser 50, and a water extractor 52. The condenser 50 and the reheater 48 are particular types of heat exchangers. The water extractor 52 is a mechanical device that performs a process of taking water from the medium. It should be appreciated that at the water extractor 52, the compressed medium A′ is at its highest pressure within the ACS 21, and therefore, the reheater 48, the condenser 50, and the water extractor 52, in combination, may be considered a high-pressure water collector. As shown, the reheater 48 may be arranged directly downstream from an outlet of the regeneration heat exchanger 40 relative to the flow of compressed medium A′, the condenser 50 may be arranged directly downstream from an outlet of the reheater 48 relative to the flow of compressed medium A′, and the water extractor 52 is arranged directly downstream from a corresponding outlet of the condenser 50 relative to the flow of compressed medium A′. However, it should be understood that the disclosed configuration of the dehumidification system is intended as an example only, and embodiments including one or more additional components are also within the scope of the disclosure.

In the illustrated, non-limiting embodiment, the compressed medium A′ output from the regeneration heat exchanger 40 is provided to the reheater 48 and condenser 50 in series, in which the compressed medium A′ is cooled, causing moisture within the cool compressed medium A′ to condense. Upon exiting the condenser 50, the compressed medium A′ enters the water extractor 52, where the condensed water or moisture is removed from the compressed medium A′. From the outlet of the water extractor 52, the compressed medium A′ makes another pass through the reheater 48. It is through this heat transfer relationship that heat from the compressed medium A′ output from the regeneration heat exchanger 40 is provided to the compressed medium A′ output from the water extractor 52.

In an embodiment, the dry, compressed medium A′ output from the second pass of the reheater 48 is then provided to an inlet of the turbine 28. Within the turbine 28, energy is extracted from the compressed medium A′ to form an expanded medium A″. The work extracted from the compressed medium A′ in the turbine 28 drives the compressor 26. It should be appreciated that in some embodiments, all or at least a portion of the flow of compressed medium A′ may be configured to bypass the turbine 28 via bypass conduit 53; however, for simplicity, the medium downstream from the turbine 28 and the outlet of the bypass conduit 53 will be referred to herein as expanded medium A″ for simplicity. The expanded medium A″ output from the turbine 28 (or the compressed medium A′ output from the bypass conduit 53) is then provided to a second pass of the condenser 50. Within the second pass, the cold expanded medium A″ (or the compressed medium A′ from the bypass conduit 53) absorbs heat from the compressed medium A′ output from the first pass of the reheater 48.

The ACS 21 may additionally be operably coupled, for example thermally coupled via one or more heat exchangers, to at least one liquid loop having a liquid circulating therethrough. In the illustrated, non-limiting embodiment, the expanded medium A″ output from the condenser 50 is provided to another heat exchanger, such as a first heat exchanger 54 configured as an air-liquid heat exchanger, also referred to herein as a “first air conditioning system heat exchanger.” At the first heat exchanger 54, the expanded medium A″ is arranged in a heat transfer relationship with a first liquid L1 circulating through a closed first liquid loop 56, such as used to cool one or more loads of the vehicle. Within the air-liquid heat exchanger 54, thermal energy is transferred between the expanded medium A″ and the first liquid L1. In an embodiment, the expanded medium A″ is heated by the first liquid L1 at the first heat exchanger 54.

The expanded medium A″ provided at the outlet of the first air-liquid heat exchanger 54 may be controlled to a desired temperature range depending on the altitude of the aircraft. In an embodiment, the expanded medium A″ output from the first air-liquid heat exchanger 54 is controlled to between 65° F. and 80° F. The conditioned, expanded medium A″ leaving the first air-liquid heat exchanger 54 may be provided to one or more loads via a conduit 58. These loads include but are not limited to the cockpit, forced air-cooled equipment, or a bay vent.

As previously noted, in some embodiments, at least a portion of the conditioned, expanded medium A″ output from the outlet of the first air-liquid heat exchanger 54 may be delivered to a downstream second air-liquid heat exchanger 60, also referred to herein as a “second air conditioning system heat exchanger,” via the regeneration pathway 44. In such instances, a valve V3 operable to control a flow through the regeneration pathway 44 to the second air-liquid heat exchanger 60 is at least partially open. This portion of the conditioned expanded medium A″ is referred to herein as diverted medium DA. In an embodiment, the second air-liquid heat exchanger 60 is also part of the liquid loop 56 through which the first liquid L1 circulates. In the illustrated, non-limiting embodiment, the second air-liquid heat exchanger 60 is arranged directly upstream from the first air-liquid heat exchanger 54 relative to the flow of the first liquid L1 within the liquid loop 56. Within the second air-liquid heat exchanger 60, thermal energy is transferred between the diverted medium DA and the first liquid L1. In an embodiment, the diverted medium DA is heated by the first liquid L1.

From an outlet of the second air-liquid heat exchanger 60, the diverted medium DA is provided to the regeneration heat exchanger 40. Within the regeneration heat exchanger 40, the diverted medium DA absorbs heat from the compressed medium A′. The resulting warmer diverted medium DA may then be exhausted overboard, dumped into a ram air circuit, or provided to another load of the aircraft. It should be understood that the A CS 21 illustrated and described herein is intended as an example only, and that an A CS having another suitable flow configuration for conditioning one or more mediums is within the scope of the disclosure. For example, embodiments having multiple thermodynamic devices and/or embodiments including a thermodynamic device having only a single turbine are within the scope of the disclosure.

The elements of the ACS 21 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves, such as valves V1, V2, V3, and V4, can be operated by actuators, such that flow rates of the medium A in any portion of the system can be regulated to a desired value.

In the illustrated, non-limiting embodiment, a secondary system, illustrated at 70, is thermally coupled to the liquid loop 56. Because the liquid loop 56 is thermally coupled to both the A CS 21 and the secondary system 70, the A CS 21 may be considered thermally coupled to the secondary system 70 by the liquid loop 56. In an embodiment, the secondary system 70 is a vapor compression system having a closed loop configuration. As shown, the secondary system 70 includes a compressor 72, a condenser 74 or heat rejection heat exchanger, an expansion device 76, and an evaporator 78 or heat absorption heat exchanger arranged to form a closed fluid loop. A working fluid R, such as a refrigerant, for example, is configured to flow from the compressor 72 to the condenser 74, to the expansion valve 76, and to evaporator 78 in series. In an embodiment, an electric motor 80 is operably coupled to the compressor 72 to produce work that the compressor 72 uses to compress the working fluid R. However, embodiments where the compressor 72 is driven alternatively or additionally by another mechanism, such as by a turbine for example, are also within the scope of the disclosure.

In the illustrated, non-limiting embodiment, the condenser 74 of the secondary system is arranged along the flow path of the first liquid L1 within the liquid loop 56. As shown, the condenser 74 may be arranged upstream from the second air-liquid heat exchanger 60 relative to the flow of the first liquid L1. Further, the condenser 74 may be arranged downstream from a load 82 of the liquid loop 56 relative to the flow of the first liquid L1. In an embodiment, the load 82 includes equipment to be cooled by the first liquid L1 of the liquid loop 56. At the condenser 74, heat from the working fluid R is released to the first liquid L1, thereby heating the first liquid L1. In an embodiment, the temperature of the first liquid L1 at the outlet of the condenser 74 is at least 225° F.

Alternatively, or in addition, the evaporator 78 of the secondary system 70 is arranged along the flow path of the first liquid L1 within the liquid loop 56. As shown, the evaporator 78 may be arranged downstream from the first air-liquid heat exchanger 54 relative to the flow of the first liquid L1. Further, the evaporator 78 may be arranged upstream from a load, such as load 82 for example, of the liquid loop 56 relative to the flow of the first liquid L1. At the evaporator 78, the working fluid R acts as a heat sink. In an embodiment, the temperature of the first liquid L1 output from the evaporator 78 is at less than about 70° F., such as less than about 65° F., or less than about 60° F. The cool first liquid L1 may then be provided to one or more loads 82 to remove heat therefrom.

The liquid loop 56 may further include a pump 84 for circulating the flow of the first liquid L1 through the liquid loop. Additionally, a recirculation conduit 86 may extend from downstream of the compressor 72 (and upstream of an inlet of the condenser 74) to a location upstream from an inlet of the evaporator 78 as shown. A valve V4 may be associated with and is operable to control a flow through the recirculation conduit 86 to control the flow of the first liquid L1 directly downstream from the load 82 or from the pump 84 and returned directly to the inlet of the evaporator 78.

In some embodiments, the first liquid L1 within the liquid loop 56 is further conditioned between the outlet of the condenser 74 and the second air-liquid heat exchanger 60. In an embodiment, the first liquid L1 is cooled directly downstream from the condenser 74 via a heat exchanger 88. A second liquid L2 from a hot liquid loop is arranged in a heat transfer relationship with the first liquid L1 at the heat exchanger 88. The second liquid L2 may be provided from any suitable source about the aircraft. Within the heat exchanger 88, the second liquid L2 acts as a heat sink to remove at least some of the heat transferred to the first liquid L1 from the working fluid R. In an embodiment, the first liquid L1 provided at an outlet of the heat exchanger 88 is less than about 180° F., and in some embodiments, less than about 175° F., less than about 170° F., or less than about 165° F.

The cool first liquid L1 may then be provided to at least one air conditioning system heat exchanger 54, 60. In an embodiment, the first liquid L1 is provided to the air-liquid heat exchangers 54, 60 in series. The expanded medium A″ and the diverted medium DA of the ACS 21 may absorb heat from the first liquid L1 within the first and second air-liquid heat exchangers 54, 60, respectively. In an embodiment, the first liquid L1 at the outlet of one of the plurality of air-liquid heat exchangers, such as at the outlet of the first air-liquid heat exchanger 54 or the outlet of the second air-liquid heat exchanger 60, has a temperature less than 100° F., such as between about 70° F. and about 100° F., or between, 80° F. and 90° F., such as 87° F. for example.

In an embodiment, the first liquid L1 of the first liquid loop 56 is fuel. However, embodiments where the first liquid is another fluid are also contemplated herein. For proper engine operation, fuel must be maintained at or below a maximum temperature. In the event that the fuel temperature exceeds the maximum operating temperature, the engine configured to receive the fuel will automatically shut down to prevent damage.

In an embodiment, operation of the A CS 21 is controllable such that the first liquid L1 output from an outlet of the air-liquid heat exchanger 54 has a desired temperature, such as less than the maximum operating temperature of the first liquid L1. In an embodiment, the first liquid L1 is provided to the condenser 74 of the secondary system 70 at or below a specific condenser temperature, such as approximately 130° F. for example, to be able to cool the working fluid R and ensure proper operation of the vapor compression cycle of the secondary system 70. The resulting heated first liquid L1 output from the condenser 74 is then delivered to the heat exchanger 88 where the first liquid L1 is arranged in a heat transfer relationship with the second liquid L2.

In an embodiment, the temperature of the first liquid L1 output from the heat exchanger 88 and/or provided to the air-liquid heat exchanger 60 may be dependent on the external or ambient air temperature and the cooling capacity of the second liquid L2. For example, on a normal or standard temperature day, the second liquid L2 has enough cooling capacity to cool the first liquid L1 to a temperature less than 100° F. In such instances, the first liquid L1 may require little cooling or no cooling within one or both of the downstream air-liquid heat exchangers 60, 54. Similarly, on a hot day, the cooling capacity of the second liquid L2 is reduced, and the first liquid L1 output from the heat exchanger 88 may have a temperature as high as 160° F. In such instances, the first liquid L1 will require significant additional cooling to reach the desired specific condenser temperature. Accordingly, the amount of heat to be removed from the first liquid L1 at the air-liquid heat exchangers 60, 54 may vary based on the ambient air temperature and/or the cooling capacity of the second liquid L2 to achieve the desired condenser temperature.

The heat removed from the first liquid L1 at the air-liquid heat exchangers 54 and/or 60 is controlled in part by at least one of the amount and the temperature of the medium A provided to the air-liquid heat exchangers 54, 60. In an embodiment, one or more valves of the ACS 21, including valve V1 associated with the flow of medium A at the inlet 22 of the A CS 21 for example, are operable to control the flow of medium A provided to ACS 21 and therefore to the at least one air-liquid heat exchanger 54, 60. During operation of aircraft on a normal or standard temperature day, the temperature of the first liquid L1 provided to the at least one air-liquid heat exchanger 54, 60 may be very close to, such as ±10° F. (higher or lower) for example, the desired temperature at the inlet of the condenser 74. For example, during operation on a standard temperature day, the temperature of the first liquid L1 at the outlet of the heat exchanger 88 may be as low as approximately 87° F. In such instances, no cooling or even minimal cooling of the first liquid L1 by the medium A of the ACS is required. Because the medium A needs to absorb only a small amount of heat if any from the first liquid L1 at the air-liquid heat exchanger 54 or 60, the amount of medium A provided to inlet 22 of the ACS 21 can be significantly reduced.

During operation on a hot temperature day, the amount of cooling of the first liquid L1 to be performed by the medium A at one or both of the air-liquid heat exchangers 54, 60 is increased relative to a standard temperature day. As a result, the amount of medium A provided to the inlet 22 of the ACS 21 pack may be increased. For example, during operation on a hot day, such as when the temperature of the first liquid L1 at the outlet of the heat exchanger 88 is approximately 165° F., around 100 PPM of medium A may be needed at the A CS 21 to sufficiently cool the first liquid L1.

The medium A conditioned within the ACS 21 disclosed herein is operable to supplement the cooling capacity of the second liquid L2 to cool the liquid L1 of the liquid loop 56. The amount of medium A used is dependent on the temperature of the first liquid L1 at the outlet of the heat exchanger 88. Such an air conditioning system 20 is extremely efficient during standard day operation and is not subject to thermal limitations of other systems that include both environmental control system and vapor cycle systems. Another advantage of this system is that the temperature of the first liquid L1 supplied to the condenser 74 is extremely low, such as 87° F. for example. As a result, the system could have a coefficient of performance of 3 or better.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An air conditioning system of a vehicle comprising:
an air cycle system configured to receive a medium and provide a conditioned form of the medium to one or more loads, the air cycle system having at least one air cycle system heat exchanger;
a vapor compression cycle having a closed loop configuration;
a liquid loop through which a first liquid circulates, the liquid loop being thermally and fluidly connected to the vapor compression cycle and the liquid loop being thermally and fluidly connected to the air cycle system at the at least one air cycle system heat exchanger;
wherein the liquid loop includes a heat exchanger arranged upstream from the at least one air cycle system heat exchanger relative to a flow of the first liquid, the first liquid being arranged in a heat transfer relationship with a second liquid at the heat exchanger; and
wherein the first liquid is cooled by at least one of the second liquid and the medium such that the first liquid has a desired temperature at a location downstream from the at least one air cycle system heat exchanger.

2. The air conditioning system of claim 1, wherein cooling of the first liquid at the at least one air cycle system heat exchanger is controlled at least partially in response to a cooling capacity of the second liquid.

3. The air conditioning system of claim 1, wherein cooling of the first liquid at the at least one air cycle system heat exchanger is controlled at least partially in response to an ambient air temperature.

4. The air conditioning system of claim 1, wherein an amount of medium provided to the air cycle system is controlled in response to at least one of a cooling capacity of the second liquid and an ambient air temperature.

5. The air conditioning system of claim 1, wherein the at least one air cycle system heat exchanger includes a first air cycle system heat exchanger and a second air cycle system heat exchanger, the first air cycle system heat exchanger and the second air cycle system heat exchanger being arranged in series relative to a flow of first liquid within the liquid loop.

6. The air conditioning system of claim 5, wherein the second air cycle system heat exchanger is arranged downstream from and in series with the first air cycle system heat exchanger relative to a flow of medium within the air cycle system.

7. The air conditioning system of claim 6, wherein the medium at an outlet of the first air cycle system heat exchanger is the conditioned form of the medium, the conditioned form of the medium being separated into a first portion deliverable to the one or more loads and a second portion deliverable to the second air cycle system heat exchanger.

8. The air conditioning system of claim 1, wherein the at least one air cycle system heat exchanger is an air-liquid heat exchanger.

9. The air conditioning system of claim 1, wherein the vapor compression cycle includes a condenser and an evaporator, the liquid loop being thermally and fluidly connected to the vapor compression cycle at at least one of the condenser and the evaporator.

10. The air conditioning system of claim 9, wherein the heat exchanger in which the first liquid is arranged in the heat transfer relationship with the second liquid is located directly downstream from the condenser relative to the flow of the first liquid.

11. The air conditioning system of claim 10, wherein the first liquid is less than or equal to a specific condenser temperature at an inlet of the condenser.

12. The air conditioning system of claim 11, wherein the specific condenser temperature is 130° F.

13. The air conditioning system of claim 1, wherein the first liquid is fuel.

14. A method of operating an air conditioning system comprising:
conditioning a medium within an air cycle system, the air cycle system including at least one air cycle system heat exchanger;
circulating a working fluid through a vapor compression system, the vapor compression system having a condenser;
circulating a first liquid through a liquid loop, the liquid loop being thermally and fluidly coupled to both the air cycle system at the at least one air cycle system heat exchanger and being thermally and fluidly coupled to the vapor compression system at the condenser; and
controlling a flow of medium at the at least one air cycle system heat exchanger such that a temperature of the first liquid at an inlet of the condenser is less than or equal to a specific condenser temperature.

15. The method of claim 14, wherein the specific condenser temperature is 130° F.

16. The method of claim 14, further comprising cooling the first liquid at the at least one air cycle system heat exchanger via the flow of medium.

17. The method of claim 14, wherein the liquid loop includes a heat exchanger, the first liquid being arranged in a heat transfer relationship with a second liquid at the heat exchanger, wherein controlling the flow of medium at the at least one air cycle system heat exchanger such that the temperature of the first liquid at the inlet of the condenser is less than or equal to the specific condenser temperature includes the controlling the flow of medium provided to the air cycle system in response to the temperature of the first liquid at an outlet of the heat exchanger.

18. The method of claim 17, wherein the temperature of the first liquid at the outlet of the heat exchanger is dependent on a cooling capacity of the second liquid at the heat exchanger.

19. The method of claim 17, wherein the temperature of the first liquid at the outlet of the heat exchanger is dependent on an ambient air temperature.

20. The method of claim 17, further comprising adjusting the flow of medium provided to the air cycle system based on a difference between the temperature of the first liquid at the outlet of the heat exchanger and the specific condenser temperature.
